(19) United States
(12) Patent Application Publication
(10) Pub. No.: US 2022/0207179 A1
(43) Pub. Date: Jun. 30, 2022

(54) AUTOMATIC CLOUD DATA DISCOVERY SYSTEMS AND METHODS

(71) Applicants: Geir Christian Karlsen, Yven (NO); Bard Frode Ronningen, Belgrade (RS)

(72) Inventors: Geir Christian Karlsen, Yven (NO); Bard Frode Ronningen, Belgrade (RS)

(21) Appl. No.: 17/594,900

(22) PCT Filed: May 2, 2020
(86) PCT No.: PCT/IB2020/054177

§ 371 Date: Nov. 2, 2021

Related U.S. Application Data
(60) Provisional application No. 62/842,428, filed on May 2, 2019.

(51) Int. Cl. G06F 21/62; G06F 21/44; G06F 21/64; G06F 21/78

(52) U.S. Cl. CPC G06F 21/6245; G06F 21/78; G06F 21/64; G06F 21/44

(57) ABSTRACT

Systems and methods for automatic cloud data discovery include a consent warehouse that authenticates with a data processor to receive an indication of data stored by the data processor and authenticates with a data controller to receive an indication of data processed by the data controller. The consent warehouse authenticates with a data subject to receive an identity of the data subject and generates, based upon the identity of the data subject, the indication of data stored, and the indication of data processed, a map indicating storage of personal data of the data subject by the data processor, and use of the personal data by the data controller. The consent warehouse interactively displays at least part of the map to the data subject and allows the data subject to manage consent for use of the personal data by the data controller.

### RELATED APPLICATION

This application claims priority to U.S. Patent Application Ser. No. 62/842,428, titled “Automatic Cloud Data Discovery Systems and Methods,” filed May 2^{nd}, 2019, which is incorporated herein in its entirety by reference.

### BACKGROUND

Personal data is frequently shared and stored by different entities without anyone tracking where or how the personal data is used. Often the owner of the personal data has no knowledge of where and how that data is used.

### SUMMARY

One aspect of the present embodiments includes the realization that more and more personal data is being collected and used without knowledge or consent of the data subject (e.g., the owner of the personal data). The present embodiments solve these problems by providing a consent warehouse for discovering where the personal data of the data subject is being stored by a data processor, discovering where that personal data is being used by a data controller, and thereby allowing the data subject to manage their personal data. Advantageously, the consent warehouse provides both control of the personal data by the data subject and provides legal basis for use of the personal data through a contract formed between the data subject and the data controller.

In one embodiment, a method for automatic cloud discovery of personal data to allow a data subject to discover where their personal data is stored and how their personal data is being used, includes: receiving, from at least one data processor, an indication of data being stored by the at least one data processor, the data processor being an entity that collects and stores data including one or more of profile information, demographic information, and behavioral data; receiving, from at least one data controller, an indication of data being processed by the at least one data controller, the data controller being an entity that processes the data stored by the data processor; generating, based upon (a) an identity of the data subject, (b) the indication of the data being stored, and (c) the indication of the data being processed, a map indicating storage of personal data of the data subject by the data processor and processing of the personal data by the data controller; and interactively displaying at least part of the map to the data subject, the map indicating where the personal data is being stored and where the personal data is being processed.

In another embodiment, a method for automatic cloud data discovery includes: authenticating with a data processor to receive an indication of data stored by the data processor; authenticating with a data controller to receive an indication of data processed by the data controller; authenticating with a data subject to receive an identity of the data subject; generating, based upon the identity, the indication of data stored, and the indication of data processed, a map indicating storage of personal data of the data subject by the data processor, and use of the personal data by the data controller; and interactively displaying at least part of the map to the data subject.

In another embodiment, a consent warehouse for automatic cloud data discovery, includes: at least one processor; and a memory storing: a database; and a consent engine and a personal data hub each having machine readable instructions that, when executed by the at least one processor, cause the at least one processor to: authenticate with a data processor to receive an indication of data stored by the data processor; authenticate with a data controller to receive an indication of data processed by the data controller; authenticate with a data subject to receive an identity of the data subject; generate, based upon the identity, the indication of data stored, and the indication of data processed, a map indicating storage of personal data of the data subject by the data processor, and use of the personal data by the data controller; and interactively display at least part of the map to the data subject.

In another embodiment, a method provides automatic cloud data discovery to allow a data subject to discover where their personal data is stored and how their personal data is being used. The method includes: authenticating with the data subject to receive an identity of the data subject, the data subject being a person or an individual; authenticating with a data processor to receive an indication of data stored by the data processor, the data processor being an entity that collects and stores personal data of the data subject including one or more of profile information, demographic information, and behavioral data; authenticating with a data controller to receive an indication of data processed by the data controller, the data controller being an entity that uses the data stored by the data processor; generating, based upon the identity, the indication of data stored, and the indication of data processed, a map indicating storage of personal data of the data subject by the data processor, and use of the personal data by the data controller; interactively displaying at least part of the map to the data subject; interacting with the data subject to receive consent for use of at least part of the personal data by the data controller; generating a contract between the data controller and the data subject indicative of the consent for use of the at least part of the personal data by the data controller; and storing the contract in a database. The contract providing legal basis for the data controller to use the personal data.

### BRIEF DESCRIPTION OF THE FIGURES

FIG. 1 shows one example automatic cloud data discovery system, in an embodiment.

FIG. 2 is a flowchart illustrating one example automatic cloud data discovery method, in an embodiment.

FIG. 3 is a flowchart illustrating another example automatic cloud data discovery method, in an embodiment.

FIG. 4 is a flowchart illustrating one example method for automatic cloud data discovery of personal data to allow a data subject to discover where their personal data is stored and how their personal data is being used, in an embodiment.

### DETAILED DESCRIPTION OF THE EMBODIMENTS

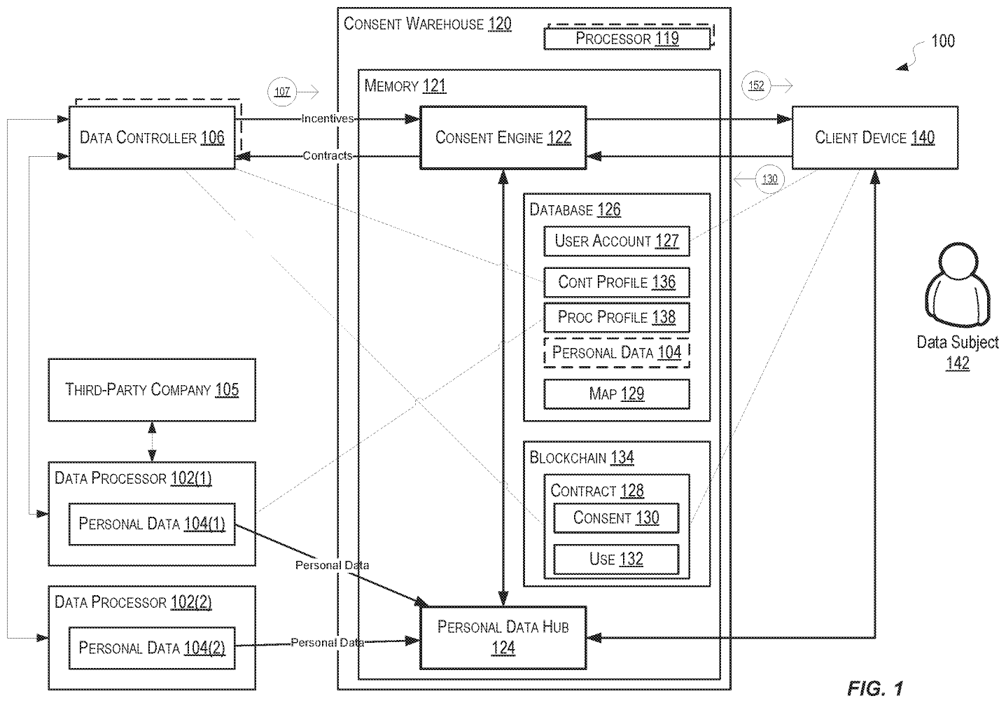

FIG. 1 shows one example of an automatic cloud data discovery system 100. System 100 allows a data subject 142 (e.g., a person or individual) to discover where their personal data 104 is stored and how their personal data 104 is being processed (e.g., used). System 100 may be implemented as a consent warehouse 120 that is a computer system (e.g., at least one computer server that includes at least one processor 119 and memory 121) that interfaces with at least one data processor 102 and at least one data controller 106. Data processor 102 may store personal data 104 and data controller 106 may process personal data 104. Consent warehouse 120 includes a consent engine 122, implemented as machine readable instructions stored in memory 121 and executable by the at least one processor 119, for managing consent of use of personal data 104. Consent warehouse 120 also includes a personal data hub 124, implemented as machine readable instructions stored in memory 121 and executable by the at least one processor 119, that provides an interface (e.g., a website) for data subject 142 to discover, view, and manage, how their personal data 104, distributed across one or more data processors 102, is being used by one or more data controllers 106. Data subject 142 may interact with consent warehouse 120 using a client device 140 (e.g., a smartphone, a mobile computer, a desktop computer, and so on). Although the example of FIG. 1 shows consent warehouse 120 interacting with one data controller 106, one client device 140 (i.e., one data subject 142), and two data processors 102, consent warehouse 120 may integrate and interact with one or more data controllers 106, one or more data processors 102, and one or more data subjects 142.

Data processor 102 may represent one or more of a natural or legal person, a public authority, an agency, and any other body that processes personal data. For example, data processor 102 may be a company and/or cloud based service such as Google, Facebook, LinkedIn, and Hootsuite that sores personal data 104 of data subject 142. For example, as data subject 142 interacts and exchanges information with data processor 102, at least part of that information may be stored by data processor 102 as personal data 104. For example, personal data 104 may include profile information, demographic information, personal data, behavioral data, and so on, that specifically relates to data subject 142. Data processor 102 may build and/or collect personal data 104 dynamically and/or selectively over time.

Data controller 106 may represent one or more of a natural or legal person, a public authority, an agency, or other body which, alone or jointly with others, determines purposes and means of processing personal data 104. For example, data controller 106 may perform statistical analysis on personal data 104 of a plurality of data subjects 142, where the personal data 104 may be stored by multiple data processors 102. However, to process personal data 104, data controller 106 needs a legal basis (e.g., an employment contract and/or explicit consent from data subject 142). Conventionally, to obtain consent of data subject 142, data controller 106 would interact with data subject 142 to request and possibly receive consent for processing of personal data 104 of data subject 142. Where data controller 106 wishes to process personal data of many data subjects, such interaction is a significant burden to data controller 106.

Consent warehouse 120 may provide a service to data controller 106 for obtaining (through integration and/or interaction with data processor(s) 102, data controllers 106, and data subjects 142) consent to use personal data 104 thereby alleviating need for data controller 106 to spend time and resources searching for, and interacting directly with, each data subject 142 to request consent for use of certain types of personal data 104. Advantageously, by collecting information from each data processor 102 authenticated with consent warehouse 120, consent warehouse 120 may determine types of personal data stored by each data processor 102, and may thereby determine which data subjects 142 may consent to use of personal data 104 by matching the requirements of data controller 106 to types of data stored by data processors 102, and then by selecting data subjects 142 associated with personal data 104 matching that data type.

Data processor 102 may authenticate (e.g., register) with consent warehouse 120, which generates a processor profile 138 defining types of data stored by data processor 102, generic data identifiers (e.g., domain names, email stems, and so on), and a list of specific identifiers corresponding to personal data 102 stored by data processor 102. In the example of FIG. 1, data processor 102 may represent a cloud storage solution (e.g., one of Google, Amazon, and so on), for a third-party company 105 (e.g., called Somecompany LTD in this example), where third-party company 105 provides its users/employees with email addresses having a common domain name (e.g., of the form name@somecompany.com). Personal data 104 stored by data processor 102 may also be identifiable through an email address that is also stored in processor profile 138. Data subject 142 may interact with personal data hub 124 to create a user account 127 associated with their email address (e.g., john.doe@somecompany.com). Personal data hub 124 may search each processor profile 138 for this email address to identify where personal data 104 of data subject 142 is stored. That is, consent warehouse 120 may automatically discover data processors 102 storing personal data 104 of data subject 142.

Data controller 106 may authenticate with consent warehouse 120 to create a controller profile 136 defining characteristics and other information of data controller 106. In certain embodiments, one or both of controller profile 136 and/or processor profile 138 may define legal basis for data controller 106 to process personal data 104 (e.g., right of access through employment contracts, and so on). For example, data controller 106 and data processor 102 may represent the same company (e.g., Google), storing and processing personal data 104, where one or more contracts (e.g., employment contract) between the employer and the employee provide legal basis that allows the data controller 106 to perform certain types of processing on part of personal data 104. However, data controller 106 may require consent from each employee (e.g., data subject 142) to perform other types of processing and/or use other parts of personal data 104. Through use of controller profile 136 and processor profile 138, personal data hub 124 may generate a map 129 of storage and use of personal data 104 of data subject 142. Map 129 may also be used to indicate other relationships between data subject 142, personal data 104, data controller 106 and data processor 102. For example, map 129 may also indicate consent 130 provided by data subject 142 for use of personal data 104 by data controller 106.

When searching for personal data to process, data controller 106 may send a request 107 defining intended processing, type of personal data 104 needed. The request 107 may also include incentives to encourage data subjects 142 to provide consent for use of their personal data 104. Consent engine 122 may search one or both of processor profiles 138 and user accounts 127 to identify and inform appropriate data subjects 142 of the incentives available for consent to use their personal data. The data subject 142 may then interact (e.g., using client device 140) with personal data hub 124 to provide consent 130 for use of their personal data 104 by data controller 106, wherein personal data hub 124 and consent engine 122 cooperate to generate a contract 128 between data subject 142 and data controller 106 defining consent 130 and use 132 of personal data 104. Contract 128 may be stored in an immutable database, such as a blockchain 134, such that it is secure and impossible to falsify or fake by any party. The embodiments use blockchain as the immutable database, but other types of database may be used without departing from the scope hereof. For example, blockchain 134 may represent one or more of a Quantum type of a ledger, an Artificial Intelligence ledger for verification of a smart contract, and so on. In embodiments, blockchain 134 is a type of distributed ledger wherein transactions between two parties may be stored in a series of permanently linked records that are verifiable and secure.

Advantageously, data subject 142 may interact with personal data hub 124 (e.g., a single entity) to learn of data controllers 106 that are processing their personal data 104, and the consent (e.g., legal basis such as an employment contract and/or explicit consent defined by contract 128) for such use, and may further interact with personal data hub 124 to manage use of their personal data 104. Personal data hub 124 may generate map 129 of use and consent based upon one or more of controller profile 136, processor profile 138, and contracts 128 stored within blockchain 134, such that data subject 142 may view map 129 to learn how their personal data 104 is being stored and used. To map consent from data subject 142 for data controller 106 to use personal data 104 stored by data processor 102, personal data hub 124 may use an identification (e.g., an email address defined within user account 127) to determine the use of personal data 104 by data controllers 106.

As described above, data controller 106 may offer incentives (e.g., rewards, points, and/or cryptocurrency) for data subject 142 to provide consent for data controller 106 to use personal data 104 and may indicate how the personal data 104 would be used. Personal data hub 124 may interact with data subject 142 to receive consent 130 for a specific use 132 of at least part of personal data 104. Personal data hub 124 may then generate contract 128 between one or more of data controller 106, data processor(s) 102, and data subject 142. Although shown within consent warehouse 120, blockchain 134 may be implemented, at least in part, external to consent warehouse 120.

Personal data hub 124 may include an interface (e.g., a web interface) that allows data subject 142 to view, using client device 140 for example, personal data 104 stored by data processor 102 (e.g., via APIs of data processor 102). Further, personal data hub 124 and consent engine 122 may cooperate to allow data subject 142 to view and manage consent related to use (e.g., processing) of personal data 104 corresponding to data subject 142. For example, data subject 142 may interact, using client device 140, with personal data hub 124 to provide and/or revoke consent 130 for use 132 of at least part of personal data 104 by data controller 106. Accordingly, consent warehouse 120 operates as a central agency for data subject 142 to manage personal data 104.

Consent engine 122 tracks (e.g., using contracts 128 stored within blockchain 134) consent 130 provided and/or removed by data subject 142. For example, consent engine 122 may maintain a map 129 to be indicative of how and where personal data 104 is being used by data controller 106. Consent engine 122 may also handle incentives 107 for consent when provided by data controller 106. For example, consent engine 122 may handle reward/incentive payout 152 to data subject 142 when data subject 142 generates contract 128 and/or as personal data 104 is used by data controller 106. Consent engine 122 and/or personal data hub 124 may identify and interact with a plurality of data subjects 142 to obtain consent 130 for use of personal data 104 by data controller 106. In one example of operation, where data processor 102(1) represents a cloud data provider, personal data 104 stored at data processor 102 may be identified as being suitable for use by data controller 106, based upon one or both of processor profile 138 and/or controller profile 136. Consent warehouse 120 may then inform corresponding data subjects 142 of the incentives and allow data subjects 142 to provide consent 130 for use of personal data 104 by data controller 106.

In another example of operation, data processor 102(1) represents cloud storage, such as provided by Google for example, as used by for data storage, emails, etc. by third-party company 105 (e.g., Somecompany LTD), and data controller 106 also represents the same company (e.g., Google) as a user of personal data 104. In this example, since it is the same company, data controller 106 already has access to personal data 104 stored by data processor 102. However, data controller 106 may not have other legal basis for using personal data 104 without consent 130 from the corresponding data subject 142. Personal data hub 124 may automatically identify third-party company 105, data processor 102 and data controller 106 as being associated with personal data 104 of data subject 142 based upon the email address associated with user account 127 of data subject 142 and processor profile 138 and controller profile 136.

Advantageously, consent warehouse 120 is a central resource that provides a single location where data subject 142, via client device 140 for example, may view and manage their personal data 104, even when it is distributed across more than one data processor 102. Once data subject 142 enrolls with consent warehouse 120 and account 127 is created, personal data hub 124 may automatically retrieve personal data 104 (e.g., profile data, employer/employee contracts, documents, and so on) corresponding to data subject 142 from data processors 102.

Personal data hub 124 allows data subject 142 to use filters, categories, searches etc. to browse through their personal data 104 and consent (e.g., legal basis and/or explicit consent provided by contracts 128) for its use. For example, data subject 142 uses client device 140 to interact with personal data hub 124 to view personal data 104, learn where personal data 104 is stored, view consent 130 provided by data subject 142 for use of personal data 104, and/or view legal basis for use of personal data 104. Advantageously, consent warehouse 120 thereby allows data subject 142 to view and control (by providing and/or revoking consent) use of distributed personal data 104, such that data subject 142 does not need to access and interact with each data processor 102. For example, consent warehouse 120 is a central location where data subject 142 may access and control their personal data 104.

Consent warehouse 120 may also provide data subject 142 with information on the legal basis for processing personal data 104 (e.g., right of access). For example, where data subject 142 is an employee of data controller 106, data controller 106 may have an employment contract that authorizes processing of certain parts personal data 102 of data subject 142. Consent warehouse 120 may allow data subject 142 to give consent for, or remove consent from, use of at least part of personal data 104 (e.g., right to object). Data subject 142 may also ask consent warehouse 120 to have at least part of personal data 104 removed or changed (e.g., right of rectification). Data subject 142 may also ask consent warehouse 120 to be removed from one or more data processors 102 and/or consent warehouse 120 (e.g., right to erasure). Data subject 142 may also ask consent warehouse 120 for restricted processing of personal data 104 (e.g., Right to restrict processing). Consent warehouse 120 may interact with one or more of data controller 106 and data processor 102 to implement the control of personal data 104 based upon the requests of data subject 142. Advantageously, consent warehouse 120 provides data subject 142 with this control of personal data 104 in a central location, thereby alleviating the need for such interfaces to be implemented by each data controller 106 and data processor 102, and also alleviating the need for data subject 142 to interact with multiple entities to determine and/or control consent for use of personal data 104.

In another example, data processor 102(1) and data processor 102(2) may operate independently (e.g., are different entities), and data subject 142 may interact directly with both data processor 102(1) and data processor 102(2) using different identities (e.g., different login credentials). Advantageously, consent warehouse 120 allows data subject 142 to link these different identities together within account 127 such that data subject 142 may collectively control, through consent warehouse 120, processing of personal data 104(1) and 104(2). For example, through a single interaction with consent warehouse 120, data subject 142 may withdraw consent 130 for use of both personal data 104(1) and personal data 104(2). In another example, through a single interaction with consent warehouse 120, data subject 142 may provide consent 130 for use of personal data 104(1) and 104(2) by data controller 106. Although linked together within account 127, consent warehouse 120 may still allow data subject 142 to control of each personal data 104(1) and personal data 104(2) independently of each other.

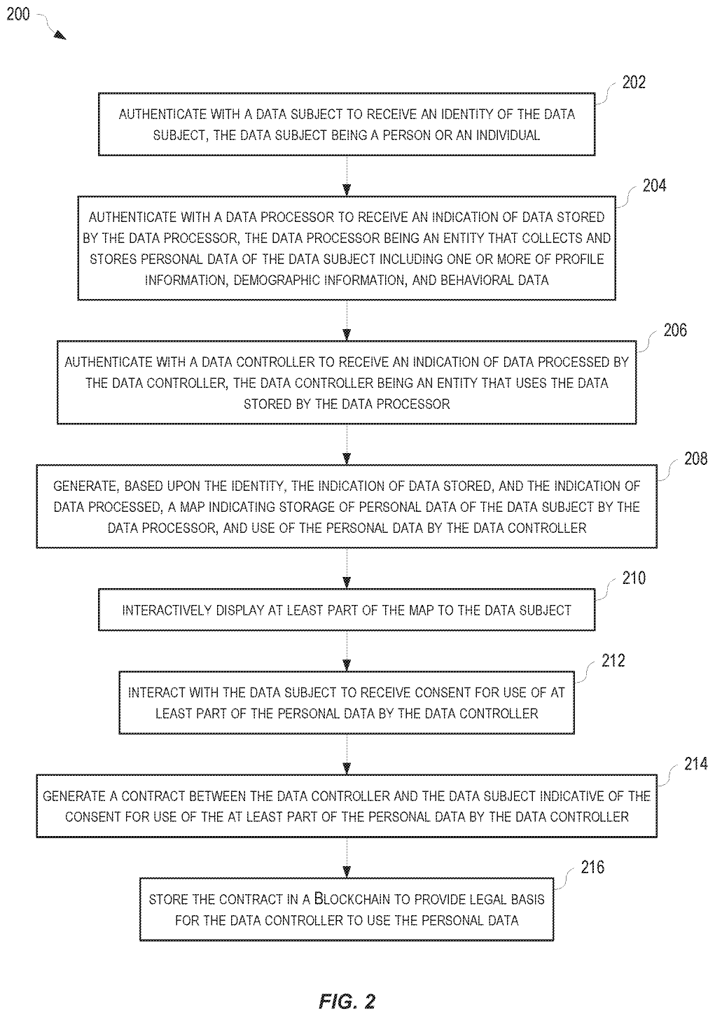

FIG. 2 is a flowchart illustrating one example method 200 for automatic cloud data discovery to allow a data subject to discover where their personal data is stored and how their personal data is being used. Method 200 may be implemented in one or both of consent engine 122 and personal data hub 124 of consent warehouse 120, for example. It should be noted that data subject 142 does not require consent for accessing their own personal data 104, and consent warehouse 120 may provide such access at any time. Method 200 is applicable to consent for use of personal data 104 by data controller 106. Data controller 106 requires legal basis (e.g., either employment or other contract and/or explicit consent 130 provided through contract 128 granted by data subject 142) for use of personal data 104.

In block 202, method 200 authenticates with a data subject to receive an identity of the data subject, the data subject being a person or an individual. In one example of block 202, personal data hub 124 authenticates with data subject 142 and receives identity information of data subject 142. In block 204, method 200 authenticates with a data processor to receive an indication of data stored by the data processor. In one example of block 204, consent engine 122 authenticates with data processor 102, which is an entity that collects and stores personal data of data subject 142 including one or more of profile information, demographic information, and behavioral data. In block 206, method 200 authenticates with a data controller to receive an indication of data processed by the data controller. In one example of block 206, consent engine 122 authenticates with data controller 106, which is an entity that uses personal data 104 stored by data processor 102. In block 208, method 200 generates, based upon the identity, the indication of data stored, and the indication of data processed, a map indicating storage of personal data of the data subject by the data processor, and use of the personal data by the data controller. In one example of block 208, consent engine 122 generates map 129 based on the identity, the indication of data stored, and the indication of data processed, where map 129 indicates storage of personal data 104 of data subject 142 by data processor 102, and use of personal data 104 by data controller 106.

In block 210, method 200 interactively displays at least part of the map to the data subject. In one example of block 210, personal data hub 124 displays at least part of map 129 to data subject 142. In block 212, method 200 interacts with the data subject to receive consent for use of at least part of the personal data by the data controller. In one example of block 212, personal data hub 124 interacts with data subject 142 to receive consent for use of personal data 104 by data controller 106. In block 214, method 200 generates a contract between the data controller and the data subject indicative of the consent for use of the at least part of the personal data by the data controller. In one example of block 214, consent engine 122 generates contract 128 between data controller 106 and data subject 142 indicative of the consent for use of at least part of personal data 104 by data controller 106. In block 216, method 200 stores the contract in a blockchain to provide legal basis for the data controller to use the personal data. In one example of block 216, consent engine 122 stores contract 128 in blockchain 134, whereby contract 128 provides legal basis for data controller 106 to user personal data 104 of data subject 142.

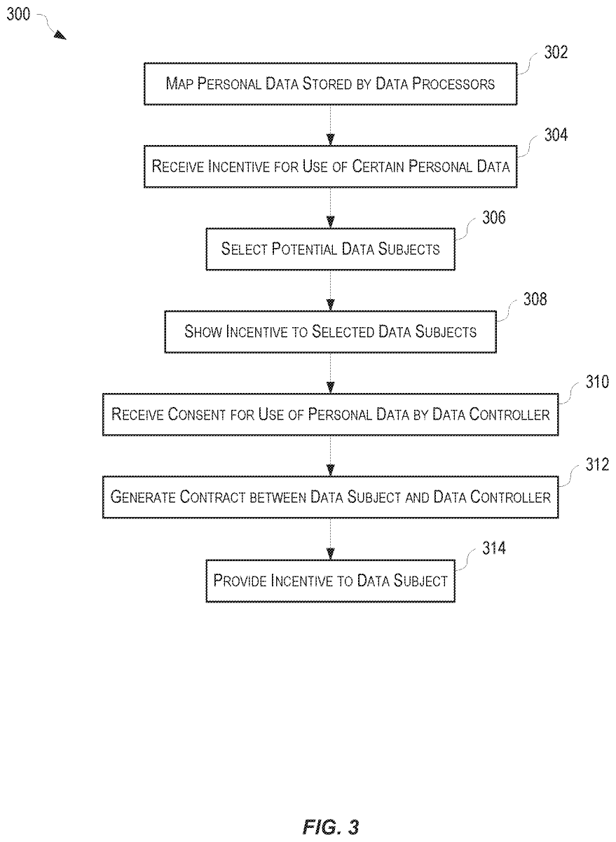

FIG. 3 is a flowchart illustrating one example method 300 for automatic cloud data discovery. Method 300 may be implemented in one or both of consent engine 122 and personal data hub 124 of consent warehouse 120, for example. It should be noted that data subject 142 does not require consent for accessing their own personal data 104, and consent warehouse 120 may provide such access at any time. Method 300 is applicable to consent for use of personal data 104 by data controller 106; data controller 106 requires legal basis (e.g., either employment or other contract and/or explicit consent 130 provided through contract 128 granted by data subject 142) for use of the personal data.

In block 302, method 300 maps personal data stored by at least one data processor. In one example of block 302, personal data hub 124 processes one or more of processor profile 138, controller profile 136, and user account 127 to generate map 129 to be indicative of storage of personal data 104 by data processor 102. In certain embodiments, block 302 may be invoked when data subject 142 enrolls with consent warehouse 120, wherein map 129 is maintained (e.g., updated in response to events associated with data subject 142 and/or periodically updated) for data subject 142 by personal data hub 124.

In block 304, method 300 receives an incentive for use of certain personal data. In one example of block 304, consent engine 122 receives a request 107, including incentives, from data controller 106 for use of certain types of personal data 104. In block 306, method 300 selects potential data subjects. In one example of block 306, personal data hub 124 and/or consent engine 122 may use map 129 to identify data subjects 142 that have personal data 104 of interest to (and not already used by) data controller 106. In block 308, method 300 shows incentives to the selected data subjects. In one example of block 308, personal data hub 124 shows incentives received in request 107 to data subject 142.

Blocks 310 through 314 illustrate interaction of method 300 with a single data subject 142; however, blocks 310 through 314 may repeat for each selected data subject 142 that responds to the incentives and provides consent 130. In block 310, method 300 receives consent for use of personal data by data controller. In one example of block 310, personal data hub 124 receives, from data subject 142 via client device 140, consent 130 for data controller 106 to use at least part (e.g., a requested data type) of personal data 104. In block 312, method 300 generates a contract between the data subject and the data processor. In one example of block 312, consent engine 122 generates contract 128 between data subject 142 and data processor 102 regarding use 132 of at least part of personal data 104 by data processor 102, and stores contract 128 in blockchain 134. In block 314, method 300 provides the incentive to the data subject. In one example of block 314, consent engine 122 sends the incentive received in request 107 to client device 140 of data subject 142.

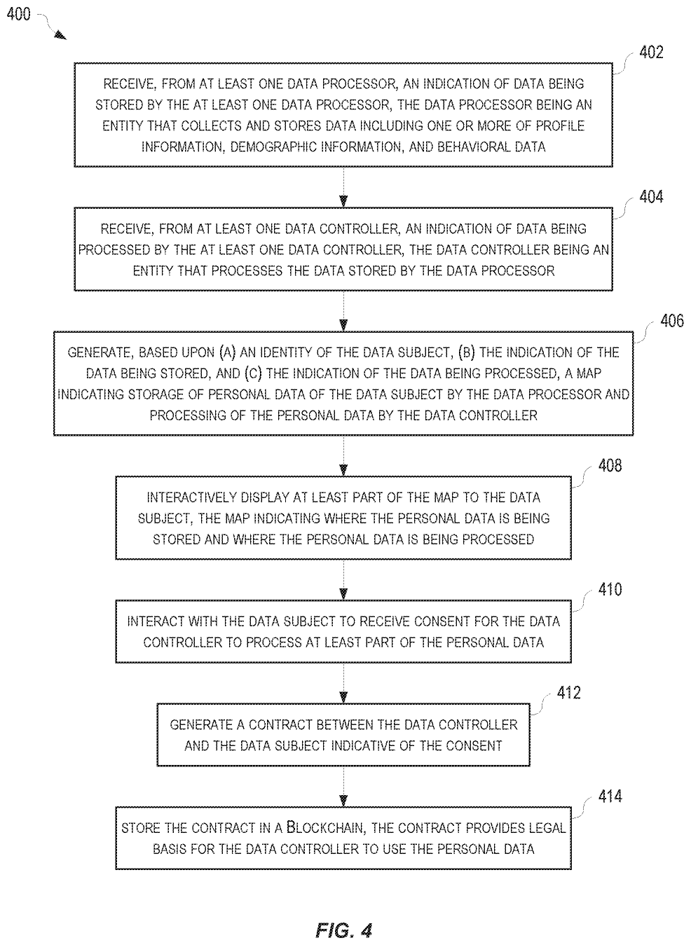

FIG. 4 is a flowchart illustrating one example method 400 for automatic cloud data discovery of personal data to allow a data subject to discover where their personal data is stored and how their personal data is being used. In block 402, method 400 receives, from at least one data processor, an indication of data being stored by the at least one data processor, the data processor being an entity that collects and stores data including one or more of profile information, demographic information, and behavioral data. In one example of block 402, consent engine 122 authenticates with data processor 102 to receive an indication of data processor 102 storing one or more of profile information, demographic information, and behavioral data. In block 404, method 400 receives, from at least one data controller, an indication of data being processed by the at least one data controller, the data controller being an entity that processes the data stored by the data processor. In one example of block 404, consent engine 122 authenticates with data controller 106 to receive an indication of data controller 106 processing data from data processor 102. In block 406, method 400 generates, based upon (a) an identity of the data subject, (b) the indication of the data being stored, and (c) the indication of the data being processed, a map indicating storage of personal data of the data subject by the data processor and processing of the personal data by the data controller. In one example of block 406, consent engine 112 generates map 129to indicate where personal data 104 of data subject 142 is stored and where that personal data 104 is processed.

In block 408, method 400 interactively displays at least part of the map to the data subject, the map indicating where the personal data is being stored and where the personal data is being processed. In one example of block 408, personal data hub 124 displays at least part of map 129 to data subject 142 via client device 140.

In block 410, method 400 interacts with the data subject to receive consent for the data controller to process at least part of the personal data. In one example of block 410, personal data hub 124 interacts with data subject 142 to receive consent for data controller 106 to process at least part of personal data 104. In block 412, method 400 generates a contract between the data controller and the data subject indicative of the consent. In one example of block 412, consent engine 122 generates contract 128 indicative of consent 130 for data controller 106 to process at least part of personal data 104. In block 414, method 400 stores the contract in a blockchain to provide legal basis for the data controller to use the personal data. In one example of block 414, consent engine 122 stores contract 128 in blockchain 134, whereby contract 128 provides legal basis for data controller 106 to use at least part of personal data 104 stored by data processor 102.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

### Combinations of Features

The features and method steps herein described may be present in embodiments in many combinations. Among those combinations are:

(A) A method for automatic cloud discovery of personal data to allow a data subject to discover where their personal data is stored and how their personal data is being used, includes: receiving, from at least one data processor, an indication of data being stored by the at least one data processor, the data processor being an entity that collects and stores data including one or more of profile information, demographic information, and behavioral data; receiving, from at least one data controller, an indication of data being processed by the at least one data controller, the data controller being an entity that processes the data stored by the data processor; generating, based upon (a) an identity of the data subject, (b) the indication of the data being stored, and (c) the indication of the data being processed, a map indicating storage of personal data of the data subject by the data processor and processing of the personal data by the data controller; and interactively displaying at least part of the map to the data subject, the map indicating where the personal data is being stored and where the personal data is being processed.

(B) The method denoted as (A), further including: authenticating each of the at least one data processors to a consent warehouse to receive the indications of data being stored; authenticating each of the at least one data controllers to the consent warehouse to receive the indications of data being processed; and authenticating the data subject to the consent warehouse to receive the identity.

(C) Either of the methods denoted as (A) or (B), further including: interacting with the data subject to receive consent for the data controller to process at least part of the personal data; generating a contract between the data controller and the data subject indicative of the consent; and storing the contract in a blockchain. The contract providing legal basis for the data controller to use the personal data.

(D) A method for automatic cloud data discovery, includes: authenticating with a data processor to receive an indication of data stored by the data processor; authenticating with a data controller to receive an indication of data processed by the data controller; authenticating with a data subject to receive an identity of the data subject; generating, based upon the identity, the indication of data stored, and the indication of data processed, a map indicating storage of personal data of the data subject by the data processor, and use of the personal data by the data controller; and interactively displaying at least part of the map to the data subject.

(E) The method denoted as (D), further including: interacting with the data subject to receive consent for use of at least part of the personal data by the data controller; generating a contract between the data controller and the data subject indicative of the consent for use of at least part of the personal data by the data controller; and storing the contract in a blockchain

(F) Either of the methods denoted as (D) or (E), further including: receiving from the data controller, an incentive for use of a certain type of personal data; selecting the data subject when the personal data of the data subject is of the certain type; and indicating the incentive to the data subject prior to interacting with the data subject to receive the consent.

(G) In any of the methods denoted as (D)-(F), the step of generating the map further including processing the contract of the blockchain to determine consent for use of the personal data, wherein the consent is interactively displayed.

(H) Any of the methods denoted as (D)-(G), further including: receiving, from the data subject, an instruction to revoke the consent for use of the personal data; generating an update to the contract to revoke the consent; and storing the updated contract in the blockchain.

(I) In any of the methods denoted as (D)-(H), the personal data being stored by at least two different data processors, the map indicating the at least two different data processors.

(J) In any of the methods denoted as (D)-(I), the step of interactively displaying at least part of the map to the data subject further comprising displaying legal basis for processing of the personal data by the data controller based upon an employment contract between the data subject and one or both of the data processor and the data controller.

(K) A consent warehouse for automatic cloud data discovery, including: at least one processor; and a memory storing: a database; and a consent engine and a personal data hub each having machine readable instructions that, when executed by the at least one processor, cause the at least one processor to: authenticate with a data processor to receive an indication of data stored by the data processor; authenticate with a data controller to receive an indication of data processed by the data controller; authenticate with a data subject to receive an identity of the data subject; generate, based upon the identity, the indication of data stored, and the indication of data processed, a map indicating storage of personal data of the data subject by the data processor, and use of the personal data by the data controller; and interactively display at least part of the map to the data subject.

(L) In the consent warehouse denoted as (K), the consent engine and the personal data hub further including machine readable instructions that, when executed by the at least one processor, cause the at least one processor to: interact with the data subject to receive consent for use of at least part of the personal data by the data controller; generate a contract between the data controller and the data subject indicative of the consent for use of at least part of the personal data by the data controller; and store the contract in a blockchain.

(M) In either of the consent warehouses denoted as (K) or (L), the consent engine and the personal data hub further including machine readable instructions that, when executed by the at least one processor, cause the at least one processor to: receive from the data controller, an incentive for use of a certain type of personal data; select the data subject when the personal data of the data subject is of the certain type; and indicate the incentive to the data subject prior to interacting with the data subject to receive the consent.

(N) In any of the consent warehouses denoted as (K)-(M), the instructions for generating the map further including machine readable instructions that, when executed by the at least one processor, cause the at least one processor to process the contract of the blockchain to determine consent for use of the personal data, wherein the consent is interactively displayed.

(O) In any of the consent warehouses denoted as (K)-(N), the consent engine and the personal data hub further including machine readable instructions that, when executed by the at least one processor, cause the at least one processor to: receive, from the data subject, an instruction to revoke the consent for use of the personal data; generate an update to the contract to revoke the consent; and store the updated contract in the blockchain.

(P) In any of the consent warehouses denoted as (K)-(O), the personal data being stored by at least two different data processors, the map indicating the at least two different data processors.

(Q) In any of the consent warehouses denoted as (K)-(P), the instructions that interactively display at least part of the map to the data subject further including machine readable instructions that, when executed by the at least one processor, cause the at least one processor to display legal basis for processing of the personal data by the data controller based upon an employment contract between the data subject and one or both of the data processor and the data controller.

(R) A method for automatic cloud data discovery to allow a data subject to discover where their personal data is stored and how their personal data is being used, includes: authenticating with the data subject to receive an identity of the data subject, the data subject being a person or an individual; authenticating with a data processor to receive an indication of data stored by the data processor, the data processor being an entity that collects and stores personal data of the data subject including one or more of profile information, demographic information, and behavioral data; authenticating with a data controller to receive an indication of data processed by the data controller, the data controller being an entity that uses the data stored by the data processor; generating, based upon the identity, the indication of data stored, and the indication of data processed, a map indicating storage of personal data of the data subject by the data processor, and use of the personal data by the data controller; interactively displaying at least part of the map to the data subject; interacting with the data subject to receive consent for use of at least part of the personal data by the data controller; generating a contract between the data controller and the data subject indicative of the consent for use of the at least part of the personal data by the data controller; and storing the contract in a database. The contract providing legal basis for the data controller to use the personal data.

What is claimed is:

1. A method for automatic cloud discovery of personal data to allow a data subject to discover where their personal data is stored and how their personal data is being used, comprising:
receiving, from at least one data processor, an indication of data being stored by the at least one data processor, the data processor being an entity that collects and stores data including one or more of profile information, demographic information, and behavioral data;
receiving, from at least one data controller, an indication of data being processed by the at least one data controller, the data controller being an entity that processes the data stored by the data processor;
generating, based upon (a) an identity of the data subject, (b) the indication of the data being stored, and (c) the indication of the data being processed, a map indicating storage of personal data of the data subject by the data processor and processing of the personal data by the data controller; and
interactively displaying at least part of the map to the data subject, the map indicating where the personal data is being stored and where the personal data is being processed.

2. The method of claim 1, further comprising:
authenticating each of the at least one data processors to a consent warehouse to receive the indications of data being stored;
authenticating each of the at least one data controllers to the consent warehouse to receive the indications of data being processed; and
authenticating the data subject to the consent warehouse to receive the identity.

3. The method of claim 1, further comprising:
interacting with the data subject to receive consent for the data controller to process at least part of the personal data;
generating a contract between the data controller and the data subject indicative of the consent; and
storing the contract in a blockchain;
wherein the contract provides legal basis for the data controller to use the personal data.

4. A method for automatic cloud data discovery, comprising:
authenticating with a data processor to receive an indication of data stored by a data processor;
authenticating with a data controller to receive an indication of data processed by the data controller;
authenticating with a data subject to receive an identity of the data subject;
generating, based upon the identity, the indication of data stored, and the indication of data processed, a map indicating storage of personal data of the data subject by the data processor, and use of the personal data by the data controller; and
interactively displaying at least part of the map to the data subject.

5. The method of claim 4, further comprising:
interacting with the data subject to receive consent for use of at least part of the personal data by the data controller;
generating a contract between the data controller and the data subject indicative of the consent for use of at least part of the personal data by the data controller; and
storing the contract in a blockchain.

6. The method of claim 5, further comprising:
receiving from the data controller, an incentive for use of a certain type of personal data;
selecting the data subject when the personal data of the data subject is of the certain type; and
indicating the incentive to the data subject prior to interacting with the data subject to receive the consent.

7. The method of claim 5, the step of generating the map further comprising processing the contract of the blockchain to determine consent for use of the personal data, wherein the consent is interactively displayed.

8. The method of claim 5, further comprising:
receiving, from the data subject, an instruction to revoke the consent for use of the personal data;
generating an update to the contract to revoke the consent; and
storing the updated contract in the blockchain

9. The method of claim 4, the personal data being stored by at least two different data processors, the map indicating the at least two different data processors.

10. The method of claim 4, the step of interactively displaying at least part of the map to the data subject further comprising displaying legal basis for processing of the personal data by the data controller based upon an employment contract between the data subject and one or both of the data processor and the data controller.

11. A consent warehouse for automatic cloud data discovery, comprising:
at least one processor; and
a memory storing:
a database; and
a consent engine and a personal data hub each having machine readable instructions that, when executed by the at least one processor, cause the at least one processor to:
authenticate with a data processor to receive an indication of data stored by the data processor;
authenticate with a data controller to receive an indication of data processed by the data controller;
authenticate with a data subject to receive an identity of the data subject;
generate, based upon the identity, the indication of data stored, and the indication of data processed, a map indicating storage of personal data of the data subject by the data processor, and use of the personal data by the data controller; and
interactively display at least part of the map to the data subject.

12. The consent warehouse of claim 11, the consent engine and the personal data hub further comprising machine readable instructions that, when executed by the at least one processor, cause the at least one processor to:
interact with the data subject to receive consent for use of at least part of the personal data by the data controller;
generate a contract between the data controller and the data subject indicative of the consent for use of at least part of the personal data by the data controller; and
store the contract in a blockchain.

13. The consent warehouse of claim 12, the consent engine and the personal data hub further comprising machine readable instructions that, when executed by the at least one processor, cause the at least one processor to:
receive from the data controller, an incentive for use of a certain type of personal data;
select the data subject when the personal data of the data subject is of the certain type; and
indicate the incentive to the data subject prior to interacting with the data subject to receive the consent.

14. The consent warehouse of claim 12, the instructions for generating the map further comprising machine readable instructions that, when executed by the at least one processor, cause the at least one processor to process the contract of the blockchain to determine consent for use of the personal data, wherein the consent is interactively displayed.

15. The consent warehouse of claim 12, the consent engine and the personal data hub further comprising machine readable instructions that, when executed by the at least one processor, cause the at least one processor to:
receive, from the data subject, an instruction to revoke the consent for use of the personal data;
generate an update to the contract to revoke the consent; and
store the updated contract in the blockchain

16. The consent warehouse of claim 11, the personal data being stored by at least two different data processors, the map indicating the at least two different data processors.

17. The consent warehouse of claim 11, the instructions that interactively display at least part of the map to the data subject further comprising machine readable instructions that, when executed by the at least one processor, cause the at least one processor to display legal basis for processing of the personal data by the data controller based upon an employment contract between the data subject and one or both of the data processor and the data controller.

18. A method for automatic cloud data discovery to allow a data subject to discover where their personal data is stored and how their personal data is being used, comprising:
authenticating with the data subject to receive an identity of the data subject, the data subject being a person or an individual;
authenticating with a data processor to receive an indication of data stored by the data processor, the data processor being an entity that collects and stores personal data of the data subject including one or more of profile information, demographic information, and behavioral data;
authenticating with a data controller to receive an indication of data processed by the data controller, the data controller being an entity that uses the data stored by the data processor;
generating, based upon the identity, the indication of data stored, and the indication of data processed, a map indicating storage of personal data of the data subject by the data processor, and use of the personal data by the data controller;
interactively displaying at least part of the map to the data subject;
interacting with the data subject to receive consent for use of at least part of the personal data by the data controller;
generating a contract between the data controller and the data subject indicative of the consent for use of the at least part of the personal data by the data controller; and
storing the contract in a database;
wherein the contract provides legal basis for the data controller to use the personal data.
